(19) United States
(12) Patent Application Publication
(10) Pub. No.: US 2008/0052930 A1
(43) Pub. Date: Mar. 6, 2008

(54) Pivotal Laser Light Directional Indicator with Attached Compass

(76) Inventor: John Suckow, Germantown, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/848,848

(22) Filed: Aug. 31, 2007

Related U.S. Application Data
(60) Provisional application No. 60/824,434, filed on Sep. 1, 2006.

(51) Int. Cl. G01C 17/02

(52) U.S. Cl. 33/354

(57) ABSTRACT

A combined laser light and compass unit comprising: a magnetic compass having a sight lens and a slotted cover to form a sight line, a laser light capable of emitting a pin-point beam and being aligned with the sight line; and a pivotal laser fight mounting member that pivotally secures the laser light to the compass such that while a user holds the combined laser light and compass unit level, the laser light marks an object at a distance with the pin-point beam in a direction chosen by said user and the pivotal laser light mounting member allows the user to mark the object upward or downward of the user.

### CROSS-REFERENCE TO RELATED APPLICATIONS

This application claims the benefit of and priority to U.S. provisional application Ser. No. 60/824,434, filed on 1 Sep. 2006 and incorporated herein in its entirety.

### FIELD OF INVENTION

This invention relates generally to the field of compasses, and specifically to the field of a compass with a laser sighting attached thereto to facilitate more precise use of the compass

### BACKGROUND

As more people participate in outdoor recreational activities, there has been a proportionate increase in the use of traditional compasses. When in use in the outdoors, a user typically holds the compass level to the ground and points the compass in the general direction in which they desire to go. Having set a general direction, the user then looks for a nearby object within the general direction they wish to head towards and then move toward that object. Once at the object sighted, they then repeat the aforementioned process to continue on their journey.

While this process tends to get the user in the general direction they desire to go, there are many and various deficiencies in this process. In using the compass to set a direction, the user has to look down at the compass to get their bearings, and once their bearing is determined, to then look up and away from the compass and chose an object to head toward. This can lead to the selection of objects that are not in the direct path that the user wants to go in because of head or body movements, selecting objects that appear to be more predominant to the sight, or other causes. In addition, if the terrain is not flat due to hills or valleys, then the selection of objects to head towards becomes more difficult because of the terrain changes relative to the compass level. Moreover, if a user is looking along the sight line, due to mental concentration, peripheral vision and/or hearing can be lost as a result. This can be particularly disadvantageous when the present invention is used for hunting or military purposes.

### BRIEF DESCRIPTION OF THE DRAWINGS

FIG. 1 is a top perspective view of one embodiment of the laser light, laser light clip, and the compass in an open position in accordance with the present invention.

FIG. 2a is a top perspective view of one embodiment of the laser light clip.

FIG. 2b is a front planar view of the embodiment of the laser light clip shown in FIG. 2a.

FIG. 3 is a side planer view of the embodiment of the laser light. laser light clip, and compass shown in FIG. 1 with the laser light pointed in an upward direction.

FIG. 4 is a side planer view of the embodiment of the laser light, laser light clip, and compass shown in FIG. 1 with the laser light pointed in a downward direction.

FIG. 5 is a side planar view of the embodiment of the laser light, laser light clip, and the compass shown in FIG. 1 in a closed position.

### DETAILED DESCRIPTION OF EMBODIMENTS OF THE INVENTION

For the purpose of promoting an understanding of the present invention, references are made in the text hereof to embodiments of a combined pivotal laser light directional indicator and compass and method of using same, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar materials from which the strap apparatus is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near indentical structural elements.

Moreover, the term “substantially” or “approximately” as used herein may be applied to modify any quantitative representation that could permissibly vary without resulting in a change in the basic function to which it is related. For example, one embodiment of the combined pivotal laser light directional indicator and compass is disclosed herein as including a clip with sidewalls that form a bore that surrounds the laser light on approximately seven eighths (⅞) of the laser light's circumference. The bore formed by the sidewalls might permissibly be more or less of a complete circle or form a closed bore and still be within the scope of the invention if its functionality is not materially altered.

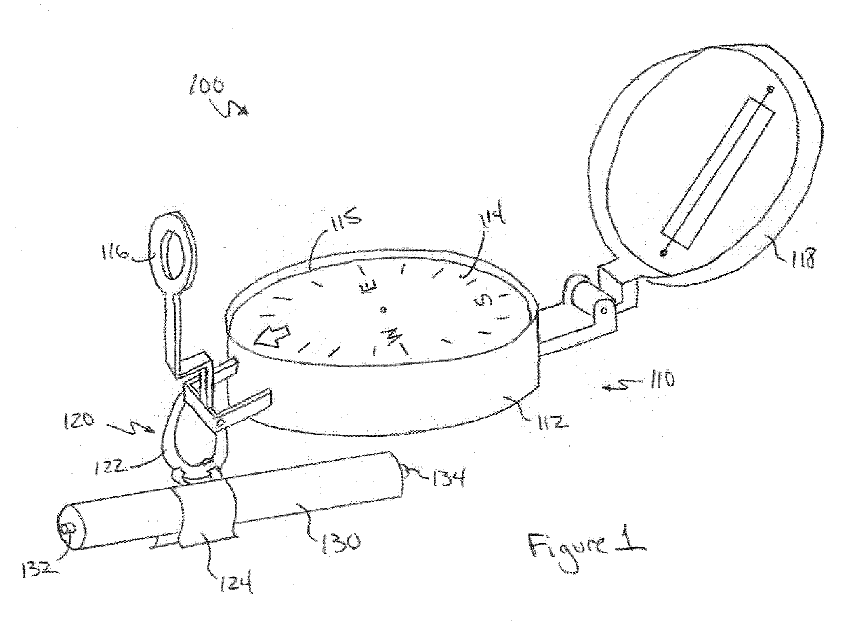

Referring now to the drawings, FIG. 1 is a top perspective view of one (1) embodiment of combined laser light and compass 100, in an open position. Combined laser light and compass 100 is comprised of compass 110, laser light mounting member 120, and laser light 130. Compass 110 includes compass base 112, compass lens 114 with sealing ring 115, sight lens 116, and slotted cover 118. Compass 110 can function as is commonly known in the art: the user holds combined laser light and compass 100 flat, determines which direction is north, orients herself in the direction she wants to travel, peers through sight lens 116 and slotted cover 118, picks a spot in the distance, travels to the spot, and repeats the procedure.

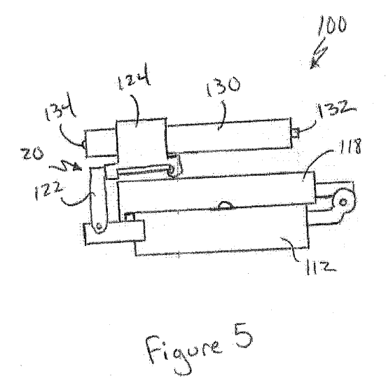

Attached to compass 110 is laser light mounting member 120. Laser light mounting member 120 is secured on one (1) end to compass 110 and on the other end is shaped to receive laser light 130. In the embodiment shown, laser light mounting member 120 includes locking bar 122 and clip 124. Locking bar 122 keeps combined laser light and compass 100 in a closed position (see the description with respect to FIG. 5) when not in use, and clip 124 attaches to locking bar 122. In the embodiment shown, locking bar 122 is made of brass, but can be made of any material commonly known and used in the art.

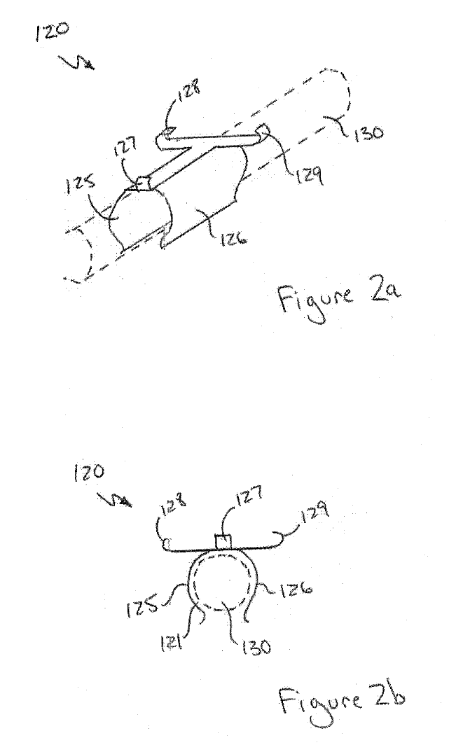

FIGS. 2a and 2b show the embodiment of clip 124 shown in FIG. 1. FIG. 2a is a top perspective view of the embodiment of clip 124 shown in FIG. 1, and FIG. 2b is a front planar view of the embodiment of clip 124 shown in FIG. 1. Referring to FIGS. 2a and 2b collectively, clip 124 includes two (2) sidewalls 125, 126, which are slightly curved to form bore 121 and to accept and secure laser light 130 (as shown in dashed lines), In the embodiment shown, sidewalls 125, 126 surround laser light 130 on approximately seven eighths (⅞) of laser light's 130 circumference, i.e., approximately three hundred fifteen degrees (315°). However, it should be understood that sidewalls 125, 126 could completely encompass laser light 130, i.e., be a closed bore, or extend around laser light 130 to a lesser or greater extent than the embodiment shown, as long as laser light 130 is secured in place. In addition, clip 124 can permanently or temporarily secure laser light 130 within clip 124. A temporary construction, however, would allow laser light 130 to be removed when not in use or replaced.

Also visible in FIGS. 2a and 2b are three (3) mounting holders 127, 128, 129. The locking bar (not shown) fits within mounting holders 127, 128, 129. Mounting holders 127, 128, 129 secure the locking bar to clip 124. The combination of the pivotal locking bar and clip 124, collectively referred to as a laser light mounting member, allows laser light 130 to be pivotally mounted to the compass (not shown). It should be understood that the combined pivotal locking bar and clip 124 is only one (1) embodiment of a laser light mounting member. Any mechanism to pivotally connect laser light 130 to the compass can be employed. For example, one (1) alternate embodiment of combined laser light and compass 100 includes a laser light mounting member in which clip 124 is directly and pivotally mounted directly to the compass. In addition, in the embodiment of combined laser light and compass shown, laser light mounting member 120, i.e., locking bar 122 and clip 124, are made of metal, but can alternately be made of plastic or any other sufficiently durable material. In addition, locking bar 122 and clip 124 need not be made of the same material in every embodiment of light mounting member.

Referring again to FIG. 1, also visible is laser light 130. Laser light 130 is temporarily secured within clip 124. When secured within clip 124, laser light 130 is parallel with the sight line created between sight lens 116 and slotted cover 118, ensuring that the pin-point light beam is aligned with the sight line. The embodiment of laser light 130 includes on/off switch 132 and light bulb 134. Other types of pin-point light beams, other than a laser light, are envisioned within the scope of the present invention.

In use, the user opens up compass 110, pivots laser light mounting member 120 with laser light 130 attached underneath compass 110, and turns on laser light 130. Once compass 110 has determined which direction is north and the user has positioned themselves in the direct they desire to go in, the user simply looks up to see what the pin-point light from laser light 130 has spotlighted. The user then turns off laser light 130, folds up combined laser light and compass 100, and moves toward the object that had been spot lighted.

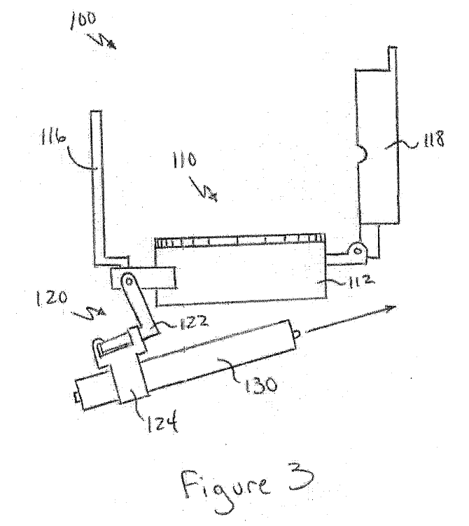

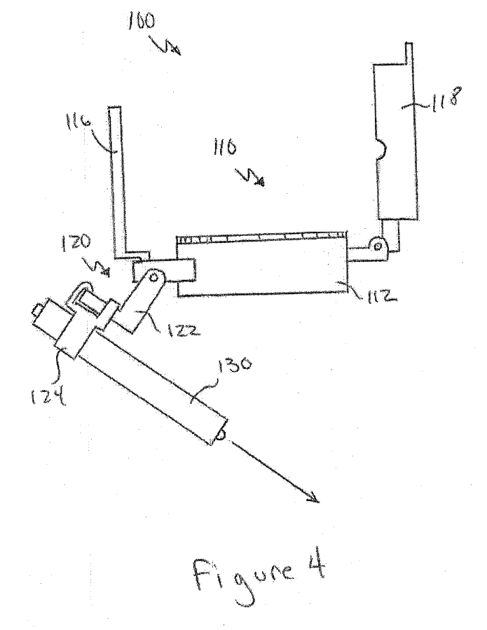

In terrain that is uneven, such as with hills and/or valleys, once the compass direction has been set, the user can pivot laser light 130 in an upward or downward direction, depending upon the terrain, by moving laser light mounting member 120 up or down while keeping the compass level, in order to spotlight an object on the uneven terrain at a distance from the user. FIG. 3 is a side planer view of the embodiment of combined laser light and compass 100 shown in FIG. 1 with laser light 130 pointed in an upward direction for spotlighting objects, for example, on a hill, and FIG. 4 is a side planer view of the embodiment of combined laser light and compass 100 shown in FIG. 1 with laser light 130 pointed in a downward direction for spotlighting objects, for example, in a valley.

Combined laser light and compass 100 can also be used on top of a map to accurately determine direction or bearing.

FIG. 5 is a side planar view of the embodiment of laser light and compass 100 shown in FIG. 1 in a closed position. Specifically, FIG. 5 shows combined laser light and compass 100 with compass base 112 covered by slotted cover 118 (the sight lens is positioned between compass base 112 and slotted cover 118 and therefore not visible) and pivotal laser light mounting member 120 positioned on top of slotted cover 118. Attached to laser light mounting member 120 is laser light 130.

While the combined laser light and compass has been shown and described with respect to several embodiments and uses in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A device comprised of:
a magnetic compass;
a laser light, said laser light capable of emitting a pin-point beam; and
a pivotal laser light mounting member, said laser light mounting member adapted to pivotally secure said laser light to said compass;
wherein, while a user holds said device level, said laser light marks an object at a distance with said pin-point beam in a direction chosen by said user, and wherein said pivotal laser light mounting member allows said user to mark said object upward or downward of said user.

2. The device of claim 1, wherein said magnetic compass further includes a sight lens and a slotted cover to form a sight line, said laser light being aligned with said sight line.

3. The device of claim 1, wherein said laser light mounting member is comprised of a pivotal locking bar and a clip, said pivotal locking bar having a first end and a second end and being secured on said first end to said magnetic compass and on said second end to said clip, and said clip having a first end and a second end and being secured on said first end to said pivotal locking bar and adapted to receive said laser light at said second end.

4. The device of claim 3, wherein said clip includes a first sidewall and a second sidewall, said first sidewall and said second sidewall both being arcuately shaped and adapted to receive said laser light.

5. The device of claim 3, wherein said clip forms a bore, said bore adapted to receive said laser light.

6. The device of claim 3, wherein said clip further includes a plurality of mounting holders, said plurality of mounting holders adapted to receive said second end of said locking bar.

7. A combined laser light and compass unit comprised of:
a magnetic compass, said magnetic compass comprising a sight lens and a slotted cover to form a sight line therebetween;
a laser light, said laser light capable of emitting a pin-point beam and being aligned with said sight line; and
a pivotal laser light mounting member, said laser light mounting member adapted to pivotally secure said laser light to said compass, and allow a user to mark an object along said sightline upward or downward of said sightline.

8. The combined laser light and compass unit of claim 7, wherein said laser light mounting member is comprised of a pivotal locking bar and a clip, said pivotal locking bar having a first end and a second end and being secured on said first end to said magnetic compass and on said second end to said clip, and said clip having a first end and a second end and being secured on said first end to said pivotal locking bar and adapted to receive said laser light at said second end.

9. The combined laser light and compass unit of claim 8, wherein said clip includes a first sidewall and a second sidewall, said first sidewall and said second sidewall both being arcuately shaped and adapted to receive said laser light.

10. The combined laser light and compass unit of claim 8, wherein said clip forms a bore, said bore adapted to receive said laser light.

11. The combined laser light and compass unit of claim 8, wherein said clip further includes a plurality of mounting holders, said plurality of mounting holders adapted to receive said second end of said locking bar.

12. A device comprised of:
a magnetic compass;
a laser light, said laser light capable of emitting a pin-point beam; and
a pivotal laser light mounting member, said laser light mounting member comprised of a pivotal locking bar and a clip, said pivotal locking bar having a first end and a second end and being secured on said first end to said magnetic compass and on said second end to said clip, and said clip having a first end and a second end and being secured on said first end to said second end of said pivotal locking bar and adapted to receive said laser light at said second end, said laser light mounting member pivotally securing said laser light to said compass;
wherein, while a user holds said device level, said laser light marks an object at a distance with said pin-point beam in a direction chosen by said user, and wherein said pivotal laser light mounting member allows said user to mark said object upward or downward of said user.

13. The device of claim 12, wherein said magnetic compass further includes a sight lens and a slotted cover to form a sight line, said laser light being aligned with said sight line.

14. The device of claim 12, wherein said clip includes a first sidewall and a second sidewall, said first sidewall and said second sidewall both being arcuately shaped and adapted to receive said laser light.

15. The device of claim 12, wherein said clip forms a bore, said bore adapted to receive said laser light.

16. The device of claim 12, wherein said clip further includes a plurality of mounting holders, said plurality of mounting holders adapted to receive said second end of said locking bar.
